(19) United States
(12) Patent Application Publication
(10) Pub. No.: US 2013/0129481 A1
(43) Pub. Date: May 23, 2013

(54) METHOD FOR DETECTING THE CORRECT ROTATIONAL DIRECTION OF A CENTRIFUGAL APPARATUS, AND A CENTRIFUGAL APPARATUS ASSEMBLY

(71) Applicants: Jussi TAMMINEN, Lappeenranta (FI); Tero AHONEN, Lappeenranta (FI); Jero AHOLA, Lappeenranta (FI); Markku NIEMELÄ, Lappeenranta (FI)

(72) Inventors: Jussi TAMMINEN, Lappeenranta (FI); Tero AHONEN, Lappeenranta (FI); Jero AHOLA, Lappeenranta (FI); Markku NIEMELÄ, Lappeenranta (FI)

(73) Assignee: ABB OY, Helsinki (FI)

(21) Appl. No.: 13/529,604

(22) Filed: Jun. 21, 2012

(30) Foreign Application Priority Data
Nov. 21, 2011 (EP) 11189925.8

(51) Int. Cl. G01P 15/14; G06F 19/00; F01D 1/06

(52) U.S. Cl. 415/118; 73/503.3; 702/148

(57) ABSTRACT

A method is disclosed for detecting the correct rotational direction of a centrifugal apparatus. The method can include detecting the correct rotational direction of the centrifugal apparatus based on an acceleration test and/or a deceleration test. The detecting of correct rotational direction of the centrifugal apparatus can include comparing an acceleration time (t_{1,acc}) for a first direction with an acceleration time (t_{2,acc}) for a second direction, whereby shorter acceleration time can be interpreted as an indication of correct rotational direction; and/or comparing a deceleration time (t_{1,dec}) of the first direction with a deceleration time (t_{2,dec}) of the second direction, whereby longer deceleration time can be interpreted as an indication of correct rotational direction.

### RELATED APPLICATION

This application claims priority under 35 U.S.C. §119 to European Patent Application No. 11189925.8 filed in Europe on Nov. 21, 2011, the entire content of which is hereby incorporated by reference in its entirety.

### FIELD

The present disclosure relates to the detection of a correct rotational direction of a centrifugal apparatus and to, for example, sensorless detection of correct rotational direction.

In centrifugal apparatuses, such as centrifugal blowers or centrifugal pumps, the direction of the fluid flow is independent from the rotational direction of the centrifugal apparatus impeller. However, if the centrifugal apparatus is rotated in the wrong direction, the produced flow rate and pressure may drop dramatically compared with the correct rotational direction. This can also reduce significantly the energy efficiency of the centrifugal apparatus.

The correctness of the rotational direction of a centrifugal apparatus should be checked in connection with installation of the centrifugal apparatus, and after any maintenance operation that could change the rotational direction of the centrifugal apparatus.

### BACKGROUND

It is known to determine the correct rotational direction of a centrifugal apparatus by visually inspecting the rotational direction. This involves additional personnel and is not an automated function. In addition, the centrifugal apparatus can be in such a position that the visual inspection can be difficult or impossible to perform.

Publication U.S. 2010/0316503 discloses a pump unit having a rotation direction recognition module for automatic recognition of the correct rotation direction of the pump. In this publication the value of flow rate, pressure or power is measured and compared between the reverse rotation and forward rotation cases. If there is a difference in the static state measurement signals between the forward and reverse rotational directions, the right rotational direction can be distinguished.

Known pump systems can involve additional instrumentation installed in to the pump system when the flow rate or pressure is used as the signal to be compared. Situations can also arise where power estimates produced by a frequency converter driving the pump are used as the signals to be compared. In these situations, pump systems can involve forward and reverse rotational speeds that have the same shaft power specification. Consequently in many cases it can be difficult or impossible to decide the correct rotational direction based on the power estimates.

### SUMMARY

A method for detecting correct rotational direction of a centrifugal apparatus is disclosed, comprising: detecting correct rotational direction of the centrifugal apparatus based on an acceleration test and/or a deceleration test, wherein the acceleration test includes: accelerating the centrifugal apparatus in a first direction from a lower acceleration speed to an upper acceleration speed; measuring an acceleration time between the lower acceleration speed and the upper acceleration speed for the first direction; accelerating the centrifugal apparatus in a second direction from the lower acceleration speed to the upper acceleration speed, the second direction being opposite to the first direction and the acceleration process in the second direction being identical to the acceleration process in the first direction; and measuring an acceleration time between the lower acceleration speed and the upper acceleration speed for the second direction; and wherein the deceleration test includes: decelerating the centrifugal apparatus rotating in a first direction from an upper deceleration speed to a lower deceleration speed; measuring a deceleration time between the upper deceleration speed and the lower deceleration speed for the first direction; decelerating the centrifugal apparatus rotating in a second direction from the upper deceleration speed to the lower deceleration speed, the second direction being opposite to the first direction and the deceleration process of the second direction being identical to the deceleration process of the first direction; and measuring a deceleration time between the upper deceleration speed and the lower deceleration speed for the second direction; and comparing the acceleration time for the first direction with the acceleration time for the second direction, whereby shorter acceleration time is interpreted as an indication of a correct rotational direction, and/or comparing the deceleration time of the first direction with the deceleration time of the second direction, whereby longer deceleration time is interpreted as indication of a correct rotational direction.

A centrifugal apparatus assembly is also disclosed comprising: a centrifugal apparatus; drive means for rotating the centrifugal apparatus; and a control unit for controlling rotation of the centrifugal apparatus, wherein the control unit is configured to detect correct rotational direction of the centrifugal apparatus by an acceleration test and/or a deceleration test, wherein during an acceleration test the control unit is configured to: accelerate the centrifugal apparatus in a first direction from a lower acceleration speed to an upper acceleration speed; measure an acceleration time between the lower acceleration speed and the upper acceleration speed for the first direction; accelerate the centrifugal apparatus in a second direction from the lower acceleration speed to the upper acceleration speed, the second direction being opposite to the first direction; and measure an acceleration time between the lower acceleration speed and the upper acceleration speed for the second direction; and wherein during the deceleration test the control unit is configured to: decelerate the centrifugal apparatus rotating in a first direction from an upper deceleration speed to a lower deceleration speed; measure an deceleration time between the upper deceleration speed and the lower deceleration speed for the first direction; decelerate the centrifugal apparatus rotating in a second direction from the upper deceleration speed to the lower deceleration speed, the second direction being opposite to the first direction; and measure an deceleration time between the upper deceleration speed and the lower deceleration speed for the second direction; wherein the control unit is configured to detect the correct rotational direction of the centrifugal apparatus by: comparing the acceleration time for the first direction with the acceleration time for the second direction, and to interpret shorter acceleration time as an indication of a correct rotational direction; and/or comparing the deceleration time of the first direction with the deceleration time of the second direction, and to interpret longer deceleration time as an indication of correct rotational direction.

### BRIEF DESCRIPTION OF THE DRAWINGS

In the following, exemplary embodiments will be described in greater detail with reference to the attached drawings, in which:

FIG. 1 shows an exemplary difference in acceleration behaviour between the forward and reverse directions for an exemplary centrifugal apparatus;

FIG. 2 shows an exemplary difference in deceleration behaviour between the forward and reverse directions for the exemplary centrifugal apparatus;

FIG. 3 shows a centrifugal apparatus assembly according to an exemplary embodiment disclosed herein; and

FIG. 4 shows an exemplary centrifugal blower impeller having backward curved airfoil blades.

### DETAILED DESCRIPTION

A method is disclosed for detecting the correct rotational direction of a centrifugal apparatus, along with an associated centrifugal apparatus assembly.

Exemplary embodiments involve a realization that a centrifugal apparatus rotated in the correct rotational direction accelerates faster and decelerates slower compared to a case where the centrifugal apparatus is rotated in the incorrect direction.

An exemplary advantage of the exemplary methods and assemblies disclosed is that the correct rotational direction of a centrifugal apparatus can be detected without any additional instrumentation.

An exemplary method for detecting the correct rotational direction of a centrifugal apparatus includes an acceleration test and a deceleration test, and detecting the correct rotational direction of the centrifugal apparatus based on the acceleration test and the deceleration test.

Herein a centrifugal apparatus can be an apparatus having an impeller and adapted to move fluids, such as liquids, gases or slurries. For example, a centrifugal apparatus may be a centrifugal blower adapted to move gases or a centrifugal pump adapted to move liquids. The rotational direction of a centrifugal apparatus means the rotational direction of the impeller of the centrifugal apparatus.

The acceleration test can include accelerating the centrifugal apparatus in a first direction from a lower acceleration speed n_{lower,acc} to an upper acceleration speed n_{upper,acc}, measuring an acceleration time t_{1,acc} between the lower acceleration speed n_{lower,acc} and the upper acceleration speed n_{upper,acc} for the first direction, accelerating the centrifugal apparatus in a second direction from the lower acceleration speed n_{lower,acc} to the upper acceleration speed n_{upper,acc}, and measuring an acceleration time t_{2,acc} between the lower acceleration speed n_{lower,acc} and the upper acceleration speed n_{upper,acc} for the second direction.

In an exemplary general case, the acceleration process is started from an initial acceleration speed n_{start,acc} and finished at a final acceleration speed n_{final,acc}. In an embodiment the initial acceleration speed n_{start,acc} is lower than the lower acceleration speed n_{lower,acc}, and the final acceleration speed n_{final,acc} is higher than the upper acceleration speed n_{upper,acc}. The initial acceleration speed n_{start,acc} may be zero.

In the acceleration test, the second direction is opposite to the first direction. The acceleration process in the second direction is identical (i.e., the same, or substantially the same so as to provide sufficient accuracy of results for the specific application at hand) to the acceleration process in the first direction. This means that a torque used to accelerate the centrifugal apparatus in the second direction can behave as a function of time identically (i.e., same, or substantially the same) with a torque used to accelerate the centrifugal apparatus in the first direction. Directions of the torques are naturally opposite relative to each other. In an exemplary embodiment each torque used in the acceleration test is a substantially constant torque. In other words the torque behaves substantially as a step function.

The deceleration test includes decelerating the centrifugal apparatus rotating in a first direction from an upper deceleration speed n_{upper,dec} to a lower deceleration speed n_{lower,dec}, measuring an deceleration time t_{1,dec} between the upper deceleration speed n_{upper,dec} and the lower deceleration speed n_{lower,dec} for the first direction, decelerating the centrifugal apparatus rotating in a second direction from the upper deceleration speed n_{upper,dec} to the lower deceleration speed n_{lower,dec}, and measuring an deceleration time t_{2,dec} between the upper deceleration speed n_{upper,dec} and the lower deceleration speed n_{lower,dec} for the second direction.

In an exemplary general case, the deceleration process is started from an initial deceleration speed n_{start,dec} and finished at a final deceleration speed n_{final,dec}. In an embodiment the initial deceleration speed n_{start,dec} is higher than the upper deceleration speed n_{upper,dec}, and the final deceleration speed n_{final,dec} is lower than the lower deceleration speed n_{lower,dec}. The initial deceleration speed n_{start,dec} may be substantially equal to the final acceleration speed n_{final,acc} in the acceleration test.

In the deceleration test, the second direction is opposite to the first direction. The first direction in the deceleration test can be the same direction as the first direction in the acceleration test. The second direction in the deceleration test can be the same direction as the second direction in the acceleration test.

The deceleration process for the second direction can be identical (i.e., the same, or substantially the same) to the deceleration process for the first direction. This means that a torque directed to the decelerating centrifugal apparatus rotating in the first direction behaves as a function of time identically (i.e., the same, or substantially the same) with a torque directed to the decelerating centrifugal apparatus rotating in the second direction. Directions of the torques are naturally opposite relative to each other. In an exemplary embodiment, the centrifugal apparatus is allowed to decelerate freely during the deceleration test. This means that no torque is used to rotate the centrifugal apparatus during the deceleration test.

The detecting of the correct rotational direction of the centrifugal apparatus can include comparing the acceleration time t_{1,acc} for the first direction with the acceleration time t_{2,acc} for the second direction, and comparing the deceleration time t_{1,dec} of the first direction with the deceleration time t_{2,dec} of the second direction. In connection with the acceleration test a shorter acceleration time is interpreted as indication of the correct rotational direction. For example, if t_{2,acc}<t_{1,acc} the second direction is the correct rotational direction, also called the forward direction. In connection with the deceleration test a longer deceleration time is interpreted as an indication of the correct rotational direction. For example, if t_{2,dec}>t_{1,dec} the second direction is the correct rotational direction.

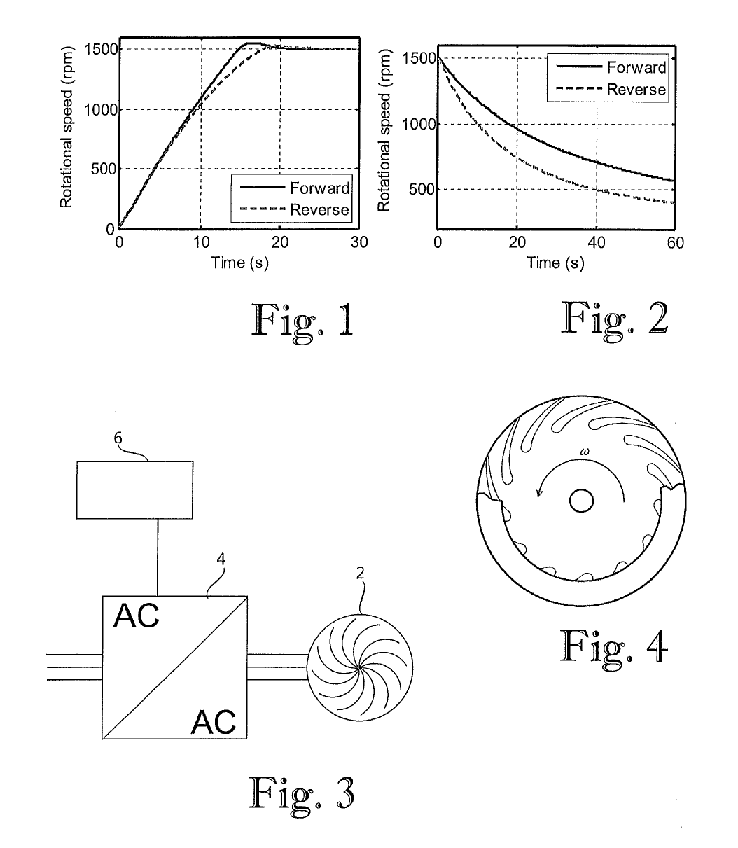

FIG. 1 shows an exemplary difference in acceleration behaviour between the forward and reverse directions. FIG. 2 shows a difference in deceleration behaviour between the forward and reverse directions. The graphs shown in FIG. 1 and FIG. 2 are only examples, the difference in acceleration and deceleration behaviour between the forward and reverse directions may vary in different embodiments.

In an exemplary embodiment, both the acceleration test and the deceleration test are repeated a plurality of times in order to improve reliability of the acceleration test and the deceleration test. In an exemplary embodiment, a certain rotational direction is designated as the correct rotational direction only if results of all tests are unanimous. In an alternative exemplary embodiment, a certain rotational direction is designated as the correct rotational direction if a given percentage, such as 90%, of the tests indicates the certain rotational direction as the correct rotational direction.

In connection with the acceleration test, numerical values of the lower acceleration speed n_{lower,acc} and the upper acceleration speed n_{upper,acc} are calculated with exemplary equations:
n_{lower,acc}=CF_{low,acc}·n_{final,acc1}
n_{upper,acc}=CF_{upper,acc}·n_{final,acc1}, where:
n_{final,acc1} is a final acceleration speed in a first direction for a step-like torque reference;
CF_{low,acc} is a coefficient for lower acceleration speed having a value between 0.1 and 0.7; and
CF_{upper,acc} is a coefficient for upper acceleration speed having a value between 0.85 and 0.99.

In connection with the deceleration, test numerical values of the upper deceleration speed n_{upper,dec} and the lower deceleration speed n_{lower,dec} can be calculated with exemplary equations:
n_{upper,dec}=CF_{upper,dec}·n_{start,dec}
n_{lower,dec}=CF_{low,dec}·n_{start,dec}, where:
n_{start,dec} is the rotational speed from which deceleration is started;
CF_{upper,dec} is a coefficient for upper deceleration speed having a value between 0.85 and 0.99; and
CF_{low,dec} is a coefficient for lower deceleration speed having a value between 0.1 and 0.7.

Optimal values of coefficients CF_{low,acc}, CF_{upper,acc}, CF_{upper,dec} and CF_{low,dec} depend on the specific exemplary embodiment. The coefficient CF_{upper,dec} for upper deceleration speed can, for example, be selected such that transients present in the beginning of the deceleration event do not distort calculation results.

It should be understood that each one of the lower acceleration speed, the upper acceleration speed, the upper deceleration speed and the lower deceleration speed discussed herein is a rotational speed. Words “acceleration” and “deceleration” are only used to clarify whether a term relates to an acceleration test or a deceleration test.

In exemplary laboratory measurements conducted with a 7.5 kW centrifugal blower having a nominal rotational speed of 1446 rpm and rotated by a 7.5 kW electric motor having a nominal rotational speed of 1450 rpm values CF_{low,acc}=CF_{low,dec}=0.3 and CF_{upper,acc}=CF_{upper,dec}=0.98 were found practical.

No separate rotation sensor is needed in cases where, for example, a centrifugal apparatus is driven by a frequency converter capable of estimating the rotational speed of the centrifugal apparatus. Many modern frequency converters are capable of estimating the rotational speed of the centrifugal apparatus they drive even during deceleration tests where no torque is used to rotate the centrifugal apparatus. Since only information relating to rotational speed is used for exemplary embodiments as disclosed herein to detect the correct rotational direction, there is no need for any additional sensors. Accordingly, exemplary embodiments disclosed herein can enable sensorless detection of the correct rotational direction.

It is possible to detect the correct rotational direction of a centrifugal apparatus by performing exclusively one or more acceleration tests. Similarly, it is possible to detect the correct rotational direction of a centrifugal apparatus by performing exclusively one or more deceleration tests. However, in many embodiments using both the acceleration test and the deceleration test can improve reliability of the detection of the correct rotational direction.

FIG. 3 shows a centrifugal apparatus assembly according to an exemplary embodiment disclosed herein. The centrifugal apparatus assembly includes a centrifugal apparatus 2, a drive means 4 (e.g., electric motor and/or associated frequency converter or other suitable device(s) for rotating the centrifugal apparatus 2, and a control unit 6 for controlling rotation of the centrifugal apparatus 2, the control unit 6 being adapted to detect the correct rotational direction of the centrifugal apparatus 2 by using the acceleration test and/or the deceleration test described herein. The drive means 4 can comprise a frequency converter of any suitable configuration, or any other suitable drive means.

In an exemplary embodiment, the centrifugal apparatus has an impeller with backward-curved blades. FIG. 4 shows an example of a centrifugal blower impeller having backward curved airfoil blades. In alternative exemplary embodiments, the centrifugal apparatus may have an impeller with forward-curved blades or with straight radial blades.

It will be apparent to hose skilled in the art that the inventive concepts disclosed herein can be implemented in various ways. The invention and its embodiments are not limited to the examples described above but may vary within the scope of the claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A method for detecting correct rotational direction of a centrifugal apparatus, comprising:
detecting correct rotational direction of the centrifugal apparatus based on an acceleration test and/or a deceleration test, wherein the acceleration test includes:
accelerating the centrifugal apparatus in a first direction from a lower acceleration speed to an upper acceleration speed;
measuring an acceleration time between the lower acceleration speed and the upper acceleration speed for the first direction;
accelerating the centrifugal apparatus in a second direction from the lower acceleration speed to the upper acceleration speed, the second direction being opposite to the first direction and the acceleration process in the second direction being identical to the acceleration process in the first direction; and
measuring an acceleration time between the lower acceleration speed and the upper acceleration speed for the second direction;
and wherein the deceleration test includes:
decelerating the centrifugal apparatus rotating in a first direction from an upper deceleration speed to a lower deceleration speed;
measuring a deceleration time between the upper deceleration speed and the lower deceleration speed for the first direction;
decelerating the centrifugal apparatus rotating in a second direction from the upper deceleration speed to the lower deceleration speed, the second direction being opposite to the first direction and the deceleration process of the second direction being identical to the deceleration process of the first direction; and
measuring a deceleration time between the upper deceleration speed and the lower deceleration speed for the second direction; and
comparing the acceleration time for the first direction with the acceleration time for the second direction, whereby shorter acceleration time is interpreted as an indication of a correct rotational direction, and/or comparing the deceleration time of the first direction with the deceleration time of the second direction, whereby longer deceleration time is interpreted as indication of a correct rotational direction.

2. A method according to claim 1, wherein the acceleration test comprises:
a substantially constant torque to accelerate the centrifugal apparatus both in the first direction and in the second direction.

3. A method according to claim 1, wherein the deceleration test allows the centrifugal apparatus to decelerate freely while no torque is used to rotate the centrifugal apparatus.

4. A method according to claim 2, comprising:
driving the centrifugal apparatus by an electric motor fed by a frequency converter, wherein the acceleration test comprises:
providing the frequency converter with a step-like torque reference, an absolute value of the step-like torque reference being a same value for the first direction and the second direction.

5. A method according to claim 4, wherein the acceleration test comprises:
calculating a numerical value of the lower acceleration speed with an equation:
n_{lower,acc}=CF_{low,acc}·n_{final,acc1}; and
calculating a numerical value of the upper acceleration speed with an equation:
n_{upper,acc}=CF_{upper,acc}·n_{final,acc1};
wherein:
n_{final,acc1} is the final acceleration speed in the first direction for the step-like torque reference;
CF_{low,acc} is a coefficient for lower acceleration speed having a value between 0.1 and 0.7; and
CF_{upper,acc} is a coefficient for upper acceleration speed having a value between 0.85 and 0.99.

6. A method according to claim 4, wherein the deceleration test comprises:
calculating a numerical value of the upper deceleration speed with an equation:
n_{upper,dec}=CF_{upper,dec}·n_{start,dec}; and
calculating a numerical value of the lower deceleration speed with an equation:
n_{lower,dec}=CF_{low,dec}·n_{start,dec};
wherein:
n_{start,dec} is the rotational speed from which the deceleration is started;
CF_{upper,dec} is a coefficient for upper deceleration speed having a value between 0.85 and 0.99; and
CF_{low,dec} is a coefficient for lower deceleration speed having a value between 0.1 and 0.7.

7. A method according to claim 1, comprising:
repeating the acceleration test and/or the deceleration test a plurality of times.

8. A centrifugal apparatus assembly comprising:
a centrifugal apparatus;
drive means for rotating the centrifugal apparatus; and
a control unit for controlling rotation of the centrifugal apparatus, wherein the control unit is configured to detect correct rotational direction of the centrifugal apparatus by an acceleration test and/or a deceleration test, wherein during an acceleration test the control unit is configured to:
accelerate the centrifugal apparatus in a first direction from a lower acceleration speed to an upper acceleration speed;
measure an acceleration time between the lower acceleration speed and the upper acceleration speed for the first direction;
accelerate the centrifugal apparatus in a second direction from the lower acceleration speed to the upper acceleration speed, the second direction being opposite to the first direction; and
measure an acceleration time between the lower acceleration speed and the upper acceleration speed for the second direction;
and wherein during the deceleration test the control unit is configured to:
decelerate the centrifugal apparatus rotating in a first direction from an upper deceleration speed to a lower deceleration speed;
measure a deceleration time between the upper deceleration speed and the lower deceleration speed for the first direction;
decelerate the centrifugal apparatus rotating in a second direction from the upper deceleration speed to the lower deceleration speed, the second direction being opposite to the first direction; and
measure a deceleration time between the upper deceleration speed and the lower deceleration speed for the second direction;
wherein the control unit is configured to detect the correct rotational direction of the centrifugal apparatus by:
comparing the acceleration time for the first direction with the acceleration time for the second direction, and to interpret shorter acceleration time as an indication of a correct rotational direction; and/or
comparing the deceleration time of the first direction with the deceleration time of the second direction, and to interpret longer deceleration time as an indication of correct rotational direction.

9. A centrifugal apparatus assembly according to claim 8, configured as a centrifugal blower to move gases.

10. A centrifugal apparatus assembly according to claim 8, configured as a centrifugal pump to move liquids.

11. A method according to claim 2, wherein the deceleration test allows the centrifugal apparatus to decelerate freely while no torque is used to rotate the centrifugal apparatus.

12. A method according to claim 3, comprising:
driving the centrifugal apparatus by an electric motor fed by a frequency converter, wherein the acceleration test comprises:
providing the frequency converter with a step-like torque reference, an absolute value of the step-like torque reference being a same for the first direction and the second direction.
